(19) United States
(12) Patent Application Publication
(10) Pub. No.: US 2022/0349026 A1
(43) Pub. Date: Nov. 3, 2022

(54) METAL PURIFYING METHOD AND METAL PURIFYING APPARATUS

(71) Applicants: KABUSHIKI KAISHA TOYOTA CHUO KENKYUSHO, Nagakute-shi (JP); TOYOTA JIDOSHA KABUSHIKI KAISHA, Toyota-shi (JP); TOYOTA TSUSHO CORPORATION, Nagoya-shi (JP)

(72) Inventors: Hiroshi KAWAHARA, Nagakute-shi (JP); Jun YAOKAWA, Nagakute-shi (JP); Kazuma HIBI, Nagakute-shi (JP); Hiroyuki MORI, Nagakute-shi (JP); Yasushi IWATA, Nagakute-shi (JP); Takuma MINOURA, Nagakute-shi (JP); Hiroyuki ISHII, Miyoshi-shi (JP); Daisuke SAKUMA, Nagoya-shi (JP); Yusei KUSAKA, Toyota-shi (JP); Akira KANO, Toyota-shi (JP); Kyosuke ITO, Nagoya-shi (JP); Satoshi NAKANO, Tahara-city (JP)

(73) Assignees: KABUSHIKI KAISHA TOYOTA CHUO KENKYUSHO, Nagakute-shi (JP); TOYOTA JIDOSHA KABUSHIKI KAISHA, Toyota-shi (JP); TOYOTA TSUSHO CORPORATION, Nagoya-shi (JP)

(21) Appl. No.: 17/720,822

(22) Filed: Apr. 14, 2022

(30) Foreign Application Priority Data
Apr. 26, 2021 (JP) 2021-073894
Mar. 18, 2022 (JP) 2022-044139

(51) Int. Cl. C22B 21/06; C22B 9/04

(52) U.S. Cl. CPC C22B 21/068; C22B 9/04

(57) ABSTRACT

A metal purifying method having: a local heating step of heating an aluminum-based molten metal in a first region on a molten metal surface of the aluminum-based molten metal; and a local low pressure step of lowering the pressure in a second region on the molten metal surface to a pressure lower than the pressure in the first region. The second region is different from the first region. This allows a specific element to be vaporized from the second region to purify the aluminum-based molten metal. The specific element is one or more of Zn, Mg, or Pb having a saturated vapor pressure higher than that of Al. This is effective not only in a purifying method for removing a specific element from an aluminum-based molten metal but also in a method of recovering a specific element, which can be a resource, from an aluminum-based molten metal.

### TECHNICAL FIELD

The present invention relates to a method of vaporizing a specific element to purify an aluminum-based molten metal and relates also to relevant techniques.

### BACKGROUND ART

With the heightened environmental awareness, lightweight aluminum-based members are being used in various fields. Rather than using aluminum that is newly smelted (and further refined), the reuse of scrap allows for promotion of the use of aluminum-based members while significantly saving energy and reducing the environmental load.

However, various elements other than Al may be mixed in a raw material molten metal (also referred to as an “Al-based molten metal) obtained by melting scrap. To prepare the Al-based molten metal as a molten metal having a desired composition, removal or reduction of unnecessary or excess elements is necessary. One of such purification methods is a vacuum distillation method (reduced-pressure distillation method, vacuum degassing method, or vacuum processing method). The vacuum distillation method for an Al-based molten metal is a method of preferentially vaporizing and separating (desorbing) elements (e.g., Zn, Mg, Pb, H, etc.) having a higher vapor pressure than that of Al from the Al-based. molten metal. The vacuum distillation method is usually performed for an Al-based molten metal having a temperature lower than the boiling point. Descriptions related to this are found in the following documents.

### PRIOR ART DOCUMENTS

### Patent Documents

[Patent Document 1] JPH6-145832A

[Patent Document 2] JPH7-41879A

[Patent Document 3] JPH9-316558A

[Patent Document 4] JPH11-256251A

[Patent Document 5] JP2001-294949A

[Patent Document 6] JP2002-339024A

[Patent Document 7] WO2011/96170

### Non-Patent Documents

[Non-Patent Document 1] Ohtaki, Saotome, Mori, Kudo, and Tanaka: Furukawa Electric Review, 104 (1999), 25

### SUMMARY OF INVENTION

### Technical Problem

Patent Documents 1 to 6 and Non-Patent Document 1 all propose to remove impurities such as Zn by vaporizing them into a vacuum atmosphere from the raw material molten metal (Al-based molten metal) which is uniformly heated as a whole. For example, in Patent Document 1, the vaporized contaminants are sucked into a processing chamber having a vacuum atmosphere provided in a part above the Al-based molten metal and recovered. Patent Document 1 assumes that an inert gas is blown i.e., bubbling) into the Al-based molten metal located on the lower side of the processing chamber. The heater provided above the processing chamber is not to actively heat the Al-based molten metal from the molten metal surface side.

In Patent Document 7, the vicinity of the surface of the aluminum molten metal in a furnace having a vacuum atmosphere is heated by arc discharge to vaporize and remove impurities such as Zn. In the purifying method of Patent Document 7, the vaporized impurities adhere to the inner wall of the furnace or return to the molten metal, and it is therefore difficult to efficiently remove or recover the impurities.

The present invention has been made in view of such circumstances and an object of the present invention is to provide a method of purifying an aluminum-based molten metal and relevant techniques for efficiently extracting a specific element using a different scheme than the conventional schemes.

### Solution to Problem

As a result of intensive studies to achieve the above object, the present inventors have succeeded in locally heating the vicinity of the surface of an aluminum-based molten metal (first region) and selectively vaporizing a specific element from a vacuum region (second region) that is different from the heating region and provided in the vicinity of the molten metal surface. Developing this achievement, the present inventors have accomplished the present invention, which will be described hereinafter.

### Metal Purifying Method

(1) The present invention provides a metal purifying method comprising: a. local heating step of heating an aluminum-based molten metal in a first region on a. molten metal surface of the aluminum-based molten metal; and a local low pressure step of lowering the pressure in a second region on the molten metal surface to a pressure lower than the pressure in the first region. The second region is different from the first region. A specific element is vaporized from the second region to purify the aluminum-based molten metal.

(2) According to the metal purifying method (also simply referred to as a “purification method”) of the present invention, the specific element contained in the aluminum-based molten metal (also referred to as an “Al-based molten metal” or simply as a “molten metal”) can be efficiently vaporized (extracted) and removed or recovered (distilled) from a specific region. The reason for this can be considered as follows.

The amount of vaporization (removal efficiency, recovery efficiency) of a specific element is greatly affected by the temperature of the molten metal near the molten metal surface (vaporization interface) and the pressure (vacuum degree) in the atmosphere above the molten metal surface. That is, the higher the molten metal temperature and the degree of vacuum, the more the vaporization of the specific element is promoted, and the larger the amount of vaporization can be.

In the local heating step of the present invention, first, the first region different from the second region in which the specific element is vaporized is locally heated. The local heating can efficiently raise the temperature near the surface of the Al-based molten metal to vaporize the specific element while avoiding large amounts of energy consumption, excessive heating time, wearing (shortening of life) of the furnace body of a heating furnace (crucible) or the like, etc. Moreover, in the case of local heating, the degree of freedom in choice and arrangement of the apparatus can be increased, and the position and range on the surface of the molten metal to be heated can be easily adjusted. For example, the second region in which the specific element is vaporized and the first region to be heated can be brought close to each other (or further brought adjacent to each other), or conversely, can be separated by an appropriate distance in consideration of the convection in the Al-based molten metal.

In the local low pressure step, the second region in which the specific element is vaporized is locally subjected to a low pressure. Therefore, the specific element can be efficiently vaporized by selectively creating a high vacuum above the surface of the Al-based molten metal while reducing the installation and maintenance costs of a large evacuation apparatus.

The synergistic action of the local heating step and the local low pressure step can efficiently vaporize the specific element contained in the Al-based molten metal. This enables the purification of the Al-based molten metal from which at least a part of the specific element is removed or the recovery of the specific element, which is an effective resource, from the Al-based molten metal (raw material). The recovered specific element is not limited in its state (gas (vapor), liquid, or solid).

When vaporizing a specific element according to the present invention, mechanical stirring or the like of the Al-based molten metal is not essential. The local heating near the molten metal surface (first region) causes convection at least in the upper layer portion of the Al-based molten metal, and the raise of the temperature of the molten metal (also simply referred to as a “molten metal temperature”) and the resupply of the specific element are continuously performed even in the second region which merges into the first region. That is, an excessively uneven temperature distribution or concentration distribution is less likely to occur between the first region and the second region even without active stirring or the like.

It suffices that the first region and the second region can communicate with each other in terms of the molten metal. That is, in a situation in which the high-temperature molten metal heated in the first region flows into the second region and the specific element is likely to vaporize from the molten metal surface in the second region, the first region and the second region may be arranged dose to each other (or further arranged adjacent to each other) or may also be arranged apart from each other.

The “vaporization” of a specific element as referred to in the present invention means that the specific element in the gaseous state leaves the surface of the molten metal (molten metal surface). The vaporization itself of the specific element may occur on the molten metal surface or inside the molten metal. That is, it can be considered that the “vaporization” as referred to in the present invention encompasses the case in which a specific element boils in the molten metal to leave the molten metal surface.

### Metal Purifying Apparatus

The present invention is also perceived as a metal purifying apparatus. For example, the present invention may provide a metal purifying apparatus comprising: a local heating means that heats an aluminum-based molten metal in a first region on a molten metal surface of the aluminum-based molten metal; and a local low pressure means that lowers the pressure in a second region on the molten metal surface to a pressure lower than the pressure in the first region. The second region is different from the first region. A specific element can be vaporized from the second region to purify the aluminum-based molten metal. Moreover, the metal purifying apparatus of the present invention may include a recovering means that recovers the specific element vaporized from the second region. Furthermore, the metal purifying apparatus of the present invention may include a differential pressure managing means that sets a differential pressure (ΔP=P1−P2) between a pressure (P1) on the first region side and a pressure (P2) on the second region side within a predetermined range.

### Regeneration Method (Apparatus)/Recovery Method (Apparatus)

(1) The present invention may also be perceived as a method of obtaining, from a scrap raw material, for example, a regenerated Al alloy from which one or more specific elements (such as Zn and Mg) are removed (regeneration method). The regenerated Al alloy from which one or more specific elements are removed may be used as a solidified material (such as an ingot) or may also be used as a molten metal (including a semi-molten state) without any modification. The regeneration of Al-based scrap may be applied not only to cascade recycling but also to upgraded recycling to expanded materials or the like.

(2) The present invention may further be perceived as a method or apparatus for recovering one or more specific elements from an Al-based molten metal (raw material) obtained by melting a raw material (e.g., scrap) (recovery method or recovery apparatus for a specific element) independently of the purification or regeneration of the Al-based molten metal.

### Others

(1) The “step” and “means” as referred to in the present specification can be substituted with each other. For example, a “-means” as substitute for a “-step” can be a feature of a “product” (such as a metal purifying apparatus), and a “-step” as substitute for a “-means” can be a feature of a “method” (such as a metal purifying method).

The temporal relationship (temporal feature) of each “step” as referred to in the present specification is not limited. For example, the local heating step and the local low pressure step may be continuously performed in parallel or alternately performed or may each be performed discretely.

(2) The first region and the second region as referred to in the present specification are sections that are defined on the surface of the Al-based molten metal for convenience. The first region may include the lower part of the molten metal surface (upper layer portion of the molten metal). The second region may include the upper part of the molten metal surface (above the molten metal), The range (upper layer region) of the molten metal to be locally heated may be, for example, about ⅓ of the depth of the molten metal.

The pressure on the first region side (P1) and the pressure on the second region side (P2) are measured, for example, by an instrument such as a gauge/sensor provided in a processing chamber (bath) or a pipe conduit (pipe arrangement) above the molten metal surface. It is not easy to stably measure the pressure in the vicinity of the molten metal surface, which is the boundary surface between the liquid phase and the gas phase, and the instrument may therefore be provided at a position that enables stable pressure measurement. During steady operation, the average value of the measured values may be adopted as the pressure in each region. Unless otherwise stated, “pressure” means the total pressure of the atmosphere in a specific space (also simply referred to as an “atmospheric pressure”). Unless otherwise stated, “pressure” refers to the absolute pressure. The difference obtained by subtracting a smaller pressure from a larger pressure (reference pressure) is also referred to as a “vacuum degree” as appropriate.

(3) The aluminum-based molten metal as referred to in the present specification involves a solid-liquid coexistence state (semi-molten state). The specific composition of the aluminum-based molten metal is not limited, provided that it contains Al as the main component (the Al content is more than 50 atomic % in an embodiment, 70 atomic % or more in another embodiment, or 85 atomic % or more in still another embodiment with respect to the molten metal as a whole). The concentration of a specific element in the raw material molten metal (Al-based molten metal before purification) is not limited, but may be usually about 10 mass % or less in an embodiment or about 5 mass % or less in another embodiment with respect to the molten metal as a whole. Unless otherwise stated, the concentration and composition as referred to in the present specification are indicated by the mass ratio (mass % or simply “%”) of an object (such as a molten metal) to the whole.

(4) Unless otherwise stated, a numerical range “x to y” as referred to in the present specification includes the lower limit x and the upper limit y. Any numerical value included in various numerical values or numerical ranges described in the present specification may be selected or extracted as a new lower or upper limit, and any numerical range such as “a to b” can thereby be newly provided by using such a new lower or upper limit.

### BRIEF DESCRIPTION OF DRAWINGS

FIG. 1 is a schematic diagram illustrating an example of the configuration of a metal purifying apparatus.

FIG. 2 is a set of photographs showing recovery filters after purification processing for Sample 1 and Sample C1.

FIG. 3 is a graph illustrating the relationship between the pressure and the discharge voltage in a processing bath.

FIG. 4 is a graph illustrating the relationship between the vapor pressure of Zn contained in an Al-based molten metal and the molten metal temperature.

FIG. 5 is a schematic diagram illustrating an example of the configuration of a metal purifying apparatus that performs differential pressure management.

FIG. 6 is a graph illustrating the relationship between the differential pressure and a molten metal head.

FIG. 7 is a diagram (one example) of steps of differential pressure management.

FIG. 8 is a set of graphs illustrating a pressure change related to differential pressure management.

### EMBODIMENTS FOR CARRYING OUT THE INVENTION

One or more features freely selected from the present specification can be added to the above-described features of the present invention. The content described in the present specification can correspond not only to a method of metal purification but also to an apparatus for metal purification. Features regarding a method can also be features regarding a product (such as an apparatus or a (regenerated) Al alloy (molten metal)).

### Local Heating

Local heating may be performed using a heat source having a high energy density. This can rapidly heat the vicinity of the molten metal surface in the first region to efficiently raise the temperature of the molten metal in the second region which merges into the first region.

### (1) Heat Source

The type, output, etc. of a heat source (apparatus) may be selected and adjusted in accordance with the form of a molten metal bath (a heating furnace, a crucible, a flow path, etc.) accommodating the molten metal, the form of the first region, and other similar factors. Examples of the heat source include high-energy beam irradiation (such as laser irradiation or electron beam irradiation) and electric discharge (such as arc discharge). Any type of the heat source can be used for simplification, downsizing, and energy saving of the heating apparatus, reduction of the load on the molten metal bath, etc.

The high-energy beam irradiation allows the heating position (first region) to be adjusted universally or with a high degree of accuracy. The electric discharge allows the vicinity of the molten metal surface to be rapidly heated by supplying high-temperature plasma. The electric discharge may be performed by disposing a pair of electrodes above the molten metal surface (above the first region) or may also be performed by disposing one electrode above the molten metal surface (above the first region) and using the Al-based molten metal (molten metal surface in the first region) as the other electrode (counter electrode). In the latter case, electric discharge occurs between the Al-based molten metal (the other electrode) and the electrode (the one electrode) disposed above the molten metal surface to efficiently and rapidly heat the molten metal in the first region. For example, when the arc discharge used for welding or the like is used, the molten metal in the vicinity of the first region can be rapidly heated to rapidly raise the temperature of the second region while reducing the burden on facilities.

### (2) Energy Density

The amount of energy per unit area (energy density) applied to the surface of the aluminum-based molten metal may be 10² W/cm² or more in an embodiment, 10³ W/cm² or more in another embodiment, or 10⁴ W/cm² or more in still another embodiment. To avoid oversizing of the apparatus and bumping near the molten metal surface just below the arc, suffice it to say that the energy density may be 10⁵ W/cm² or less.

### (3) Arc Discharge

Heating by the arc discharge (arc heating) is performed with a high-temperature arc column generated between electrodes. The temperature of the arc column varies depending on its portion, but the temperature is at least higher than that of flames or the like (<3000° C.) and reaches, for example, 4000° C. or higher or even 5000° C. or higher (reference: Tanaka, Journal of the Japan Welding Society, 77 (2008), 50). Heating near the molten metal surface by the arc column may be direct arc heating or indirect arc heating. The arc heating is considered to be mainly due to the irradiation (radiation) or the transfer of kinetic energy of particles (such as electrons and plasma ions) or the like. The arc heating as referred to in the present specification includes arc plasma heating in which the arc discharge is constrained by a nozzle, a gas flow, or the like to enhance the directional characteristics and the heating temperature. The power source for the arc discharge may be direct current or alternating current.

The arc discharge may be performed in an atmosphere near the atmospheric pressure to quasi-atmospheric pressure (about 10⁵ to 10⁴ Pa) or in a depressurized (low) vacuum atmosphere (about 10⁴ to 10² Pa). When the arc discharge is performed in a vacuum atmosphere, the stabilization can be achieved and the amount of heat input to the molten metal can be stably increased.

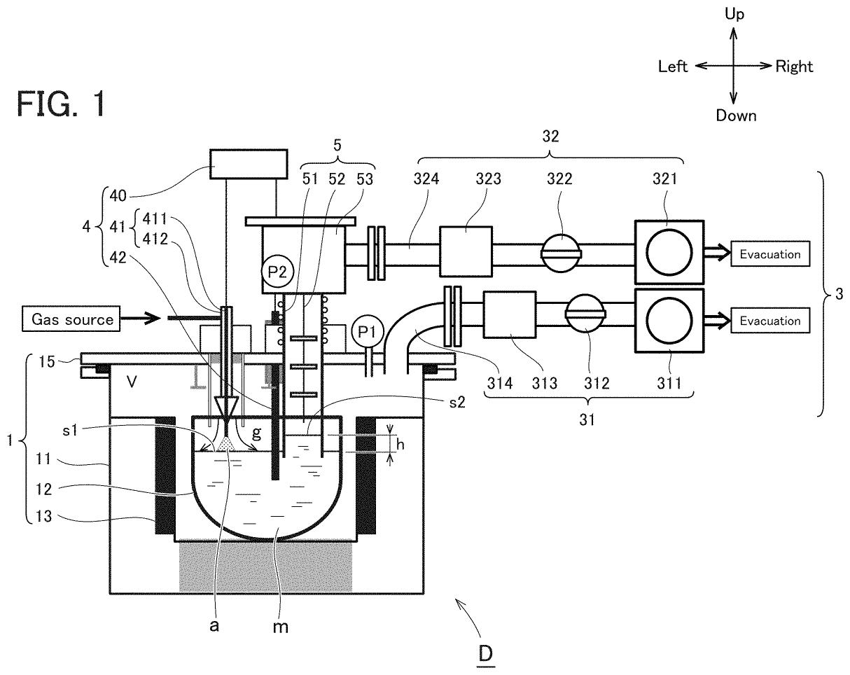

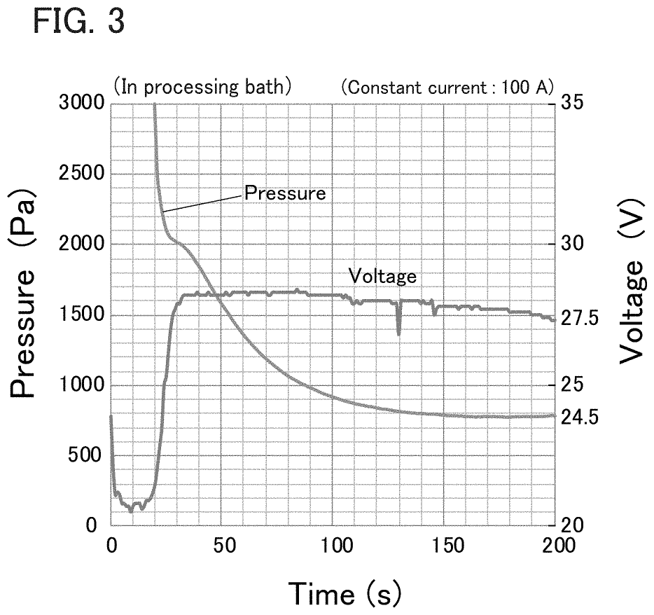

As an example, FIG. 3 illustrates the relationship between the pressure (atmospheric pressure in a processing chamber v) and the discharge voltage obtained by performing the arc discharge (constant current: 100 A) in a holding bath 1 using a metal purifying apparatus D illustrated in FIG. 1, which will be described later. From FIG. 3, it has been found that when the arc discharge is performed in a predetermined vacuum atmosphere, the discharge voltage stably increases, and a desired amount of heat input can be applied to a molten metal m.

In consideration of this result, when the first region is heated by the arc discharge, the pressure (P1) in the first region may be, for example, 500 to 2000 Pa in an embodiment, 650 to 1750 Pa in another embodiment, or 800 to 1500 Pa in still another embodiment.

Moreover, by increasing the degree of vacuum on the first region side (i.e., by reducing P1), it is possible to suppress the oxidation of the Al-based molten metal heated to a high temperature. If the degree of vacuum becomes unduly high, the amount of vaporization from the first region side will also increase, and the vaporized material may be deposited on the surroundings (such as the furnace wall and the bath wall) to deteriorate the maintenance properties.

### Local Low Pressure

The local low pressure allows the second region to be in a lower pressure than the surroundings (at least the first region). This can preferentially vaporize a specific element from the vicinity of the molten metal surface in the second region and improve the recoverability of the specific element.

The pressure (P2) on the second region side can be adjusted as appropriate and is, for example, 0.1 to 1000 Pa in an embodiment, 1 to 100 Pa in another embodiment, or 5 to 50 Pa in still another embodiment. As the degree of vacuum on the molten metal surface in the second region is increased (P2 is reduced), the partial pressure of the specific element on the molten metal surface can be reduced, and the vaporization amount and recovery amount of the specific element can be increased.

However, if the pressure (P2) on the second region side is unduly small with respect to the pressure (P1) on the first region side, that is, if the differential pressure (ΔP=P1−P2) between the two is unduly large, the height of a molten metal column on the second region (molten metal column in the bath body) will be high and cause an increased size, damage, or the like of the entire equipment. In this regard, the differential pressure (ΔP) may be, for example, about 100 to 5000 Pa in an embodiment, 200 to 1000 Pa in another embodiment, or 300 to 800 Pa in still another embodiment. The pressure (P1) on the first region side may be set, for example, to 100 to 10000 Pa in an embodiment, 200 to 5000 Pa in another embodiment, or 400 to 2500 Pa in still another embodiment, depending on the local heating source.

The pressure reduction in the second region is performed, for example, by a cylindrical or tubular bath body (further, a chamber) surrounding the molten metal surface in the second region and a space above it, and an evacuation means (such as a vacuum pump) that evacuates the inside of the bath body.

To stably perform purification of the Al-based molten metal and recovery of a specific element, the height difference between the molten metal surface in the first region and the molten metal surface in the second region (the height difference will be referred to as a “molten metal column height” or a “molten metal head”), or the pressure difference (ΔP=P1−P2) between the first region side and the second region side, may be managed (maintained) within respective predetermined ranges. Various specific schemes for this are conceivable. The description herein will he made for an exemplary case in which the differential pressure is managed (adjusted, controlled, etc.) to allow the molten metal column height to he within a predetermined range (differential pressure managing step, differential pressure managing means).

Differential pressure management is performed by decreasing P1 and/or increasing P2. For example, if the second region side is made to communicate with the higher pressure side (first region side, atmospheric atmosphere, etc.) at a predetermined time, the differential pressure management can be easily performed. The differential pressure management may be performed continuously or consecutively or may also be performed only when the differential pressure, the molten metal column height, or the like deviates from a predetermined range. Perception of the differential pressure itself (such as measurement or detection) may not be always necessary for the differential pressure management. For example, a pressure valve (switching valve/differential pressure managing means) that operates by using the differential pressure as a drive source when the differential pressure falls outside a predetermined range may be simply interposed between the pressure circuits on the first region side and the second region side.

As will be understood, the differential pressure manage may be performed while perceiving the differential pressure. For example, precise differential pressure management may be performed using a differential pressure managing means including a differential pressure gauge (including a pressure gauge, a vacuum gauge, a coupled gauge, or the like) that can directly or indirectly perceive the differential pressure, a control valve that allows the second region (above the molten metal surface) and the high pressure region to communicate with each other or shuts off the communication, and a controller that operates the control valve based on the pressure (signal) perceived by the differential pressure gauge. The differential pressure may be a directly measured differential pressure ΔP, a difference between the measured P1 and P2, or a value estimated from one of the P1 and P2. For example, when one of the P1 and P2 is stable, the pressure of the other may be used as substitute for the differential pressure.

### Specific Element

A specific element having a higher vapor pressure (saturated partial vapor pressure, which will be described later) than that of Al vaporizes from the molten metal surface in the second region to a vacuum atmosphere (also simply referred to as a “mid-space”) located above the molten metal surface and is fractionally distilled.

### (1) Vapor Pressure

Saturated vapor pressure (equilibrium vapor pressure) depends on the temperature and increases as the temperature rises. The saturated vapor pressure (P₀) of an elementary substance of pure metal (liquid phase) is represented by the following Equation (1) as a function of temperature (T) (Source: Osafune: Bulletin of Tsuyama National College of Technology 13 (1975) 63):

log P₀=aT⁻¹+blogT+cT+D (1)

where log: common logarithm, T: absolute temperature (K), a, b, c, and D: constants.

Saturated vapor pressure (Pt) at a temperature T of the entire molten metal composed of a plurality of constituent elements is represented by the following Equation (2) as the sum of partial pressures of the saturated vapor pressures (Pᵢ: each referred to as a saturated partial vapor pressure) of the constituent elements (Source: Osafune: Bulletin of Tsuyama National college of Technology 13 (1975) 63):

Pt=ΣPᵢ=Σ(αᵢPᵢ₀) (2)

where αᵢ: activity of a constituent element in the molten metal, Pᵢ₀: saturated vapor pressure of the elementary substance of a constituent element (liquid phase). The activity (αᵢ) depends on the concentration of a constituent element in the molten metal and the temperature of the molten metal.

When the saturated partial vapor pressure (Pi) of a constituent element contained in the molten metal is larger than the partial pressure of the constituent elements in the mid-space, that constituent element can vaporize (can be released or dissipated) from the molten metal surface to the mid-space, in the case of an Al-based molten metal, theoretically, each constituent element including Al can vaporize to above the molten metal in accordance with the saturated partial vapor pressure and the partial pressure on the molten metal surface.

Note, however, that the saturated vapor pressure of Al is negligibly smaller than the saturated vapor pressures of other elements contained in the Al-based molten metal. This is the same even when considered as a saturated partial vapor pressure with consideration for activity. For example, the saturated vapor pressure at 700° C. is Al: 2×10⁻⁵ Pa, Zn: 8.4×10³ Pa, Mg: 7.5×10² Pa, and Pb: 6.7×10⁻¹ Pa. Thus, even when the activity (concentration) is taken into consideration, the vapor pressures (saturated partial vapor pressures) of other elements are about 10³ to 10⁷ times higher than that of Al. That is, in the Al-based molten metal, there is a large vapor pressure difference between Al and a specific element. In the first region and the second region, therefore, Al does not substantially vaporize, and a specific element having a larger vapor pressure than that of Al mainly vaporizes. In the present specification, unless otherwise stated, the above-described saturated partial vapor pressure is simply referred to as a “vapor pressure.”

### (2) Specific Element

Examples of the specific element having a large difference in the vapor pressure (saturated partial vapor pressure) with respect to Al include one or more of Zn, Mg, or Pb. A typical example of the specific element is Zn whose vapor pressure is particularly high.

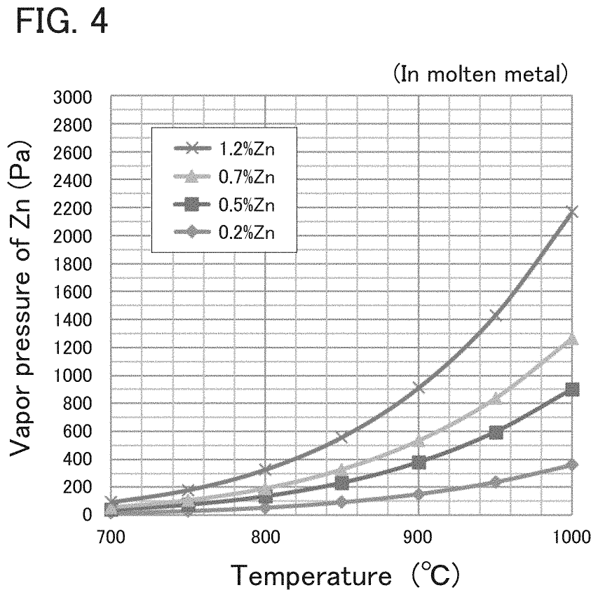

As an example, FIG. 4 illustrates the results of calculating the vapor curves (relationships between the vapor pressure and the molten metal temperature) of Zn contained in Al alloy molten metals based on the above-described Equations (1) and (2). The activity (αᵢ) in Equation (2) is calculated and obtained from the Zn concentration and the temperature using thermodynamic calculation software (“Thermo-Calc” available from Thermo-Calc Software AB), The Zn concentration (mass %) is set to 0.2%, 0.5%, 0.7%, or 1.2% as illustrated in FIG. 4. As found from FIG. 4, the vapor pressure of Zn increases as the molten metal temperature rises. Even with the same molten metal temperature, the higher the concentration of Zn, the higher the vapor pressure of Zn.

The vapor pressure of such a specific element increases as the molten metal temperature rises, and by further reducing the pressure in the mid-space above the molten metal surface, the specific element is likely to vaporize from the molten metal, and the removal efficiency or recovery efficiency is enhanced (reference: Ohtaki, Saotome, Mori, Kudo, and Tanaka: Furukawa Electric Review, 104 (1999), 25).

### Purification

The purification for vaporizing a specific element from the Al-based molten metal may be performed by a batch process (collective process) or may also be performed by a continuous process (consecutive process). According to the batch process, the degree of freedom can be large in setting the pressure in the processing chamber (e.g., the space on the second region side), the temperature near the molten metal surface, the processing time, etc. According to the continuous process, a large amount of the Al-based molten metal can be efficiently treated, and the process can be smoothly linked with other impurity removal processes, subsequent casting steps, etc.

### Recovery

The specific element may be captured/recovered and reused as a resource. In this regard, the present invention may include a recovering step (means) for recovering the specific element vaporized from the second region.

The specific element is recovered, for example, by aggregating/solidifying the vapor of the specific element with a filter or a cooler (such as a corrugated cooling tube). A part of the specific element can vaporize also from other than the second region (such as the first region), but most of the specific element vaporizes in the second region having a low pressure (further a high vacuum). Therefore, when the vapor of the specific element generated from the second region is aggregated/solidified, the specific element can be efficiently recovered. The specific element may be recovered not only in a solid state, but also in a gas (vapor) state, a liquid state, or a solid-liquid coexistence state.

### Local Heating Means

Arc discharge as a suitable example of the local heating source will then be described.

### (1) Electrodes

As one of the electrodes, for example, a torch electrode having a tip portion facing the surface of the Al-based molten metal may be used. Energization (application of voltage) between the torch electrode and the Al-based molten metal allows the arc discharge to occur between the tip portion of the torch electrode and the surface of the Al-based molten metal.

The energization to the Al-based molten metal is performed, for example, through a molten metal bath composed of a conductor such as metal or through a counter electrode at least a part of which is immersed in the Al-based molten metal. Like the torch electrode, the counter electrode at least a part of which is immersed in the molten metal may be disposed, for example, on the upper side of the Al-based molten metal. This can integrate, above the Al-based molten metal, the configuration/function required for the local heating, and advantages are obtained, such as downsizing of the apparatus, improvement of the maintenance properties, and improvement of the workability for supplying/replacing, the Al-based molten metal (molten metal bath).

The outer peripheral surface of the torch electrode may be surrounded by an insulator. This can suppress the free discharge, and the arc discharge generated between the tip portion of the torch electrode and the surface (local) of the Al-based molten metal can be stabilized. The free discharge is electric discharge that can occur between the torch electrode (including the outer peripheral surface) and the counter electrode surface, the wall surface of the molten metal bath, the surface of the Al-based molten metal, or the like. The range in which the insulator surrounds the outer peripheral surface of the torch electrode may be a range in which the free discharge can be suppressed. In general, the insulator preferably extends to the vicinity of the tip portion of the torch electrode.

The insulator may be in a cylindrical/tubular form into which the torch electrode is inserted (fitted) or may also be in a film-like form that covers the outer surface of the torch electrode. When the insulator constitutes at least a part of the flow path for a gas supplied onto the surface of the Al-based molten metal, it is possible to downsize and simplify the configuration on the torch side.

The arc discharge may use a hot cathode arc or a cold cathode arc. In any case, the torch electrode may be a cathode (negative electrode). At that time, the wall surface of the molten metal bath or processing chamber and the Al-based molten metal (counter electrode) may be at approximately the same electric potential, The electrode (torch electrode, counter electrode) exposed to high temperature may be composed of a high boiling point material such as carbon (graphite) or tungsten (W). The form of the electrode is not limited, but the electrode is usually in a (circular) columnar form or a (round) rod-shaped form.

### (2) Gas Flow

The arc discharge may be performed while applying a gas flow onto the surface of the aluminum-based molten metal (particularly to the first region). The gas flow is, for example, a gas stream composed of an inert gas alone such as Ar, He, or N₂ ejected from a nozzle or the like or a mixed gas thereof or may also be a gas stream or a plasma stream ejected from the torch electrode side. The gas flow may be applied continuously or intermittently.

### EXAMPLES

### First Example

The local heating step and the local low pressure step were carried out on an Al-based molten metal containing Zn to perform the fractional distillation and recovery of Zn by a vacuum distillation method. The present invention will be described in more detail based on such specific examples.

### Apparatus

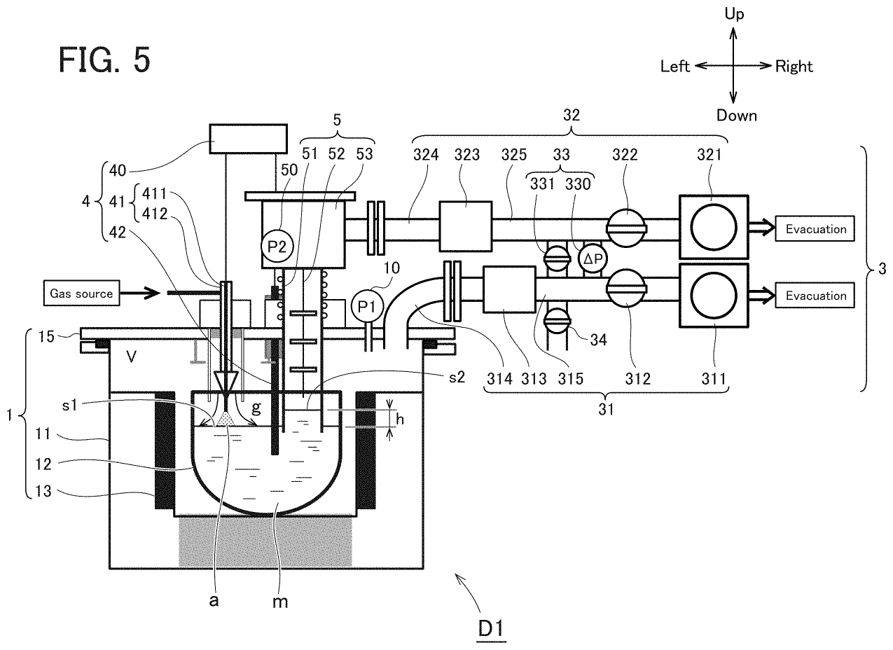

FIG. 1 schematically illustrates the overview of a metal purifying apparatus D (simply referred to as an “apparatus D”). For descriptive purposes, the arrow direction illustrated in the figure is referred to as an up-down direction or a right-left direction. The same applies to FIG. 5, which will be described later.

The apparatus D includes a holding bath 1 that heats and holds an Al-based molten metal m (simply referred to as a “molten metal in”), a local heating unit 4 that heats the vicinity of a molten metal surface s1 (first region) of the molten metal m, and a local low pressure unit 5 that creates a high vacuum near a molten metal surface s2 (second region) of the molten metal m.

The holding bath 1 (heating furnace) includes a housing 11, a crucible 12 (molten metal bath) that accommodates the molten metal m, a heater 13 that can melt a raw material metal (such as aluminum-based scrap) and adjust the temperature of the molten metal m in the crucible 12, and a lid body 15 that closes the upper part of the housing 11 to form a processing chamber v (upper space) closed in the holding bath 1. The crucible 12 is made of alumina and the heater 13 is of an electric resistance type.

The processing chamber v is depressurized by an evacuation unit 31. The evacuation unit 31 includes an oil-sealed rotary vacuum pump 311 (first evacuation means), a regulation valve 312 that regulates the pressure (degree of vacuum) in the processing chamber v, an evacuation filter 313 that traps vapor, fine particles, and other similar substances suctioned from the processing chamber v, and an evacuation pipe 314 that communicates with the processing chamber v. The regulation valve 312 operates based on the measured value (P1) of a pressure gauge 10.

The local heating unit 4 (local heating means) includes a power source 40, a torch 41, and a counter electrode 42 that generate arc discharge “a.” The torch 41 includes an electrode 411 (torch electrode) and a gas pipe 412 that surrounds the electrode 411. An inert gas (Ar) is supplied to the gas pipe 412 from a gas source (such as a cylinder) located on the upstream side. The gas pipe 412 is composed of an insulating material such as ceramics.

A power source for TIG (Tungsten Inert Gas) welding was used as the power source 40. Both the electrode 411 and the counter electrode 42 were round rod-shaped electrodes, and the tip portion of the counter electrode 42 was immersed in the upper part of the molten metal m. When energization is applied between the electrode 411 and the counter electrode 42 by the power source 40, the arc discharge “a” occurs between the molten metal surface s1 and the tip portion (vicinity of the tip surface) of the electrode 411 located in the mid-space above the vicinity of the molten metal surface s1. The arc discharge “a” causes at least a part of the gas supplied from the gas pipe 412 to be continuously converted to plasma, and an arc column or a plasma flow is stably generated.

A part of the inert gas released from the downstream side of the gas pipe 412 becomes a gas stream g along the outer circumference of the arc discharge “a” and the molten metal surface s1. The molten metal surface s1 is stably heated by the gas stream g. The vapor generated on the molten metal surface s1 by the gas stream g diffuses along the surface of the molten metal m and is guided to the evacuation unit 31. A part of the vapor becomes liquid or solid as the temperature decreases, and accumulates in the evacuation pipe 314 and the filter 313.

The local low pressure unit 5 (local low pressure means) includes a cylindrical body 51 whose one end side is immersed in the vicinity of the molten metal surface s2 (second region), a recovery filter 52 inserted in the cylindrical body 51, and a chamber 53 that holds the other end side of the cylindrical body 51 in an airtight manner. The chamber 53 is depressurized by an evacuation unit 32. The evacuation unit 32 includes an oil-sealed rotary vacuum pump 321 (second evacuation means), a regulation valve 322 that regulates the pressure (degree of vacuum) in the chamber 53, an evacuation filter 323 that traps vapor, fine particles, and other similar substances passing through the recovery filter 52 and reaching the chamber 53, and an evacuation pipe 324 that communicates with the chamber 53. The cylindrical body 51 is made of a heat-resistant insulating material such as ceramics. The regulation valve 322 operates based on the measured value (P2) of a pressure gauge 50. In the present embodiment, the evacuation unit 31 and the evacuation unit 32 are collectively referred to as an “evacuation unit 3” in a simple term.

The pressure (P1) in the processing chamber v and the pressure (P2) in the chamber 53 are usually set to P2<(P1<P0 (atmospheric pressure). Therefore, a height difference (molten metal head: h) is generated between the molten metal surface s1 and the molten metal surface s2 in accordance with the pressure difference (ΔP=P1−P2) and the density (p) of the molten metal m.

### Purification

The above-described apparatus D was used for purification (specific element removal/recover) of each Al-based molten metal (raw material molten metal) containing Zn (specific element) as listed in Table 1. This will be specifically described.

### (1) Al-based Molten Metal

As the Al-based molten metal (raw material molten metal) before purification, a molten metal of Al-1.2% Zn was prepared in the crucible 12. The Zn concentration is the mass ratio of Zn to the entire molten metal or alloy. Commercially available pure Al and pure Zn were used as the metal raw materials to be the molten metal. The amount of Al-based molten metal used for each sample was 6000 g.

The molten metal temperature was measured at a depth position of about 25 mm from the molten metal surface s1. The molten metal temperature before the local heating was set to 750° C. for all the samples.

### (2) Depressurization

The vacuum pumps 311 and 321 were operated to evacuate the processing chamber v and chamber 53 in a closed state to reduce the pressure. The pressure in the processing chamber v (PT: absolute pressure) and the pressure in the chamber 53 (P2: absolute pressure) were set as listed in Table 1. The processing time listed in Table 1 is the elapsed time after P1 and P2 reach the pressures listed in Table 1 (discharge time when locally heating). The depressurization of the chamber 53 corresponds to the local low pressure step as referred to in the present invention.

A pipe (inner diameter: 60 mm) made of ceramics (aluminum titanate) was used. as the cylindrical body 51. The lower end portion of the cylindrical body 51 was immersed in the molten metal m by about 10 mm from the molten metal surface s1.

The height difference (h) generated between the molten metal surface s1 and the molten metal surface s2 due to the decompression by the evacuation unit 3 was about 3 cm for both Sample 1 and Sample 2.

### (3) Arc Discharge (Local Heating Step)

For Samples 1 and 2, the power source 40 was operated for energization to heat the molten metal surface s1 by the arc discharge “a” from the processing start time. The arc discharge “a” was achieved by a DC arc using the electrode 411 as the negative electrode (cathode) and the counter electrode 42 as the positive electrode (anode). A tungsten rod of Φ3.2 mm was used as the electrode 411, and a graphite rod of Φ6 mm was used as the counter electrode 42.

The lower end portion of the counter electrode 42 was immersed in the molten metal to a depth position of about 50 mm from the molten metal surface s1. The discharge current associated with the arc discharge “a” and the gas flow rate of Ar forming the gas stream g are as listed in Table 1. The discharge time is the processing time listed in Table 1.

For Sample C1, only the depressurization of the chamber 53 was performed without operating the power source 40 for energization or supplying a gas to the molten metal surface s1, while keeping the molten metal temperature at 750° C.

Evaluation/Measurement

### (1) Recovery of Specific Element

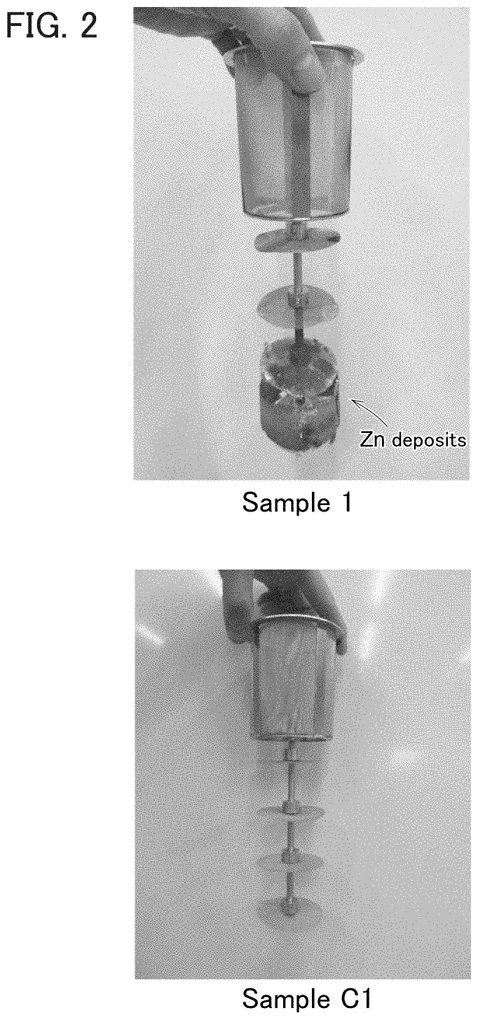

For Sample 1 and Sample C1, the appearance of the recovery filter 52 after the purification is shown in FIG. 2. As found from FIG. 2, deposits were confirmed in the lower part of the recovery filter 52 of Sample 1 which was locally heated near the molten metal surface s1. On the other hand, no such deposits were recognized in the recovery filter 52 of Sample C1 which was not locally heated.

Thus, it has been found that Zn (specific element) can be vaporized and recovered from the molten metal m within a short time by heating the molten metal surface s1 side (first region) while creating a high vacuum on the molten metal surface s2 side (second region).

### (2) Removal of Specific Element

For Sample 2, after completion of the local heating (arc discharge), the molten metal m was cooled (in the furnace) for 600 seconds while maintaining the degree of vacuum in the holding bath 1 (processing chamber v). After that, the inside of the processing chamber v was opened to the air, and the cooled molten metal m was taken out. A part of the cooled molten metal m was injected into a stainless steel analytical mold and solidified by natural cooling in the air. The chemical component (Zn concentration) of the Al alloy thus obtained was measured by fluorescent X-ray spectroscopy. The Zn concentration was 0.65 mass %. It has therefore been found that the Zn concentration of the molten metal m is reduced from the initial 1.2 mass % to 0.65 mass % by the above-described purification.

As in the case of Sample 1, Zn deposits were confirmed in the lower part of the recovery filter 52 of Sample 2. The mass increase of the recovery filter 52 was about 80% of the Zn decrease in the molten metal m calculated from the above-described change in the Zn concentration. That is, it has been found that about 80% of the Zn vaporized from the entire molten metal m is recovered (i.e., the Zn recovery rate is 80%) by the recovery filter 52 provided in the cylindrical body 51 on the molten metal surface s2 side.

From the above, it has been found that the specific element can be efficiently distilled fractionally or recovered from the Al-based molten metal within a short time by heating the first region of the Al-based molten metal and creating a high vacuum in the different second region merging into the first region as in the present invention.

### Second Example

The present invention will be described in detail below with reference to a specific example of differential pressure management associated with the above-described metal purification (fractional distillation/recovery of a specific element).

### Apparatus

FIG. 5 schematically illustrates the overview of a metal purifying apparatus D1 (simply referred to as an “apparatus D1”) used in the present example. The same members, devices, etc. as those illustrated in FIG. 1 are designated by the same reference numerals, and detailed descriptions thereof are omitted.

The apparatus D1 has a configuration in which a differential pressure managing unit 33 and a leak valve 34 are added to the apparatus D. The differential pressure managing unit 33 (differential pressure managing means) includes a differential pressure gauge 330 and a control valve 331. Both the differential pressure gauge 330 and the control valve 331 are interposed between pipes 315 and 325. The pipe 315 is provided between the regulation valve 312 and the evacuation filter 313 while the pipe 325 is provided between the regulation valve 322 and the evacuation filter 323. The leak valve 34 is provided on the pipe 315. When the leak valve 34 is opened, the inside of the pipe 315 is opened to the air.

The control valve 331 opens and closes based on the differential pressure detected by the differential pressure gauge 330. Specifically, when the detected differential pressure is a predetermined threshold or less, the control valve 331 can shut off the communication between the pipe 315 and the pipe 325 to generate a desired differential pressure (ΔP=P1−P2) between the processing chamber v and the chamber 53. On the other hand, when the detected differential pressure exceeds the predetermined threshold, the control valve 331 allows the pipe 315 and the pipe 325 to communicate with each other to make the processing chamber v and the chamber 53 substantially the same pressure (P1≈P2, ΔP≈0) so that the molten metal surface s1 and the molten metal surface s2 are substantially the same height (molten metal head: h≈0).

### Differential Pressure Management

### (1) Molten Metal Head

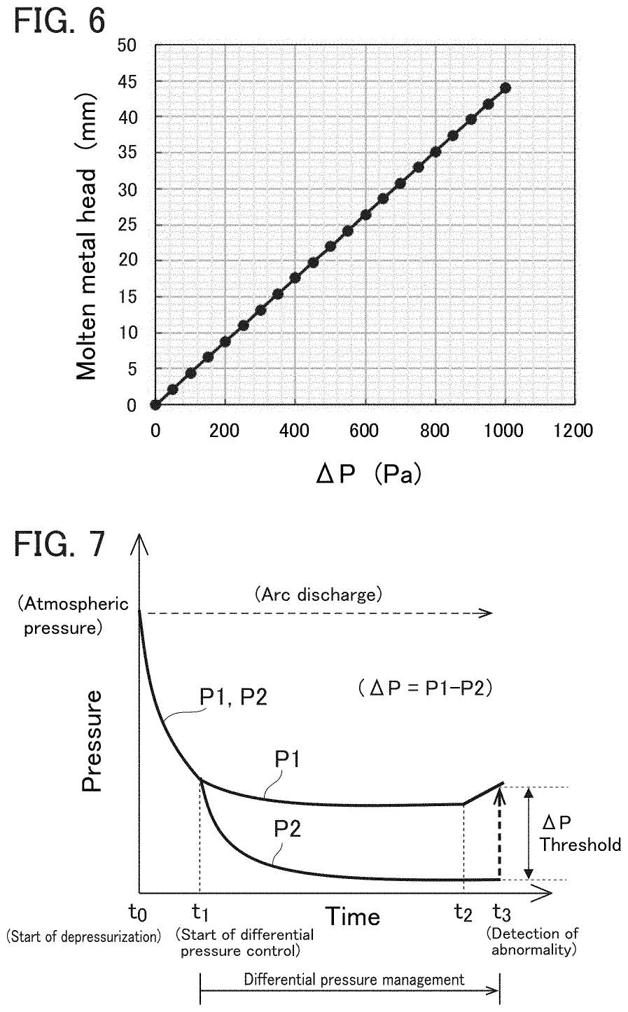

The relationship between the differential pressure (ΔP=P1−P2) between the processing chamber v and the chamber 53 and the height difference (molten metal head) generated between the molten metal surface s1 and the molten metal surface s2 was obtained by calculation. FIG. 6 illustrates an example when the molten metal m is the previously described Al-based molten metal (Al-1.2% Zn).

### (2) Steps

FIG. 7 illustrates an example of steps of the differential pressure management. Specifically, first, the vacuum pumps 311 and 321 are operated to reduce the pressure in the processing chamber v and the chamber 53 (time t0/step S0). Then, after the processing chamber v and the chamber 53 reach a predetermined degree of vacuum, the regulation valves 312 and 322 are used to lower the pressure (P2) in the chamber 53 to a pressure lower than the pressure (P1) in the processing chamber v (time t1/step S1). After the differential pressure (ΔP) between the two falls within a predetermined range (becomes a predetermined threshold or lower), the leak valve 34 is slightly opened. In this way, the pressure (P1) in the processing chamber v suddenly increased, causing an intentional disturbance (time t2/step S2). The differential pressure gauge 330 detects an abnormality in which the differential pressure (ΔP) exceeds the predetermined threshold, and the control valve 331 opens. As a result, the pipe 315 and the pipe 325 communicate with each other, and the processing chamber v and the chamber 53 are made equal pressure (time t3/step S3).

### (3) Experiment

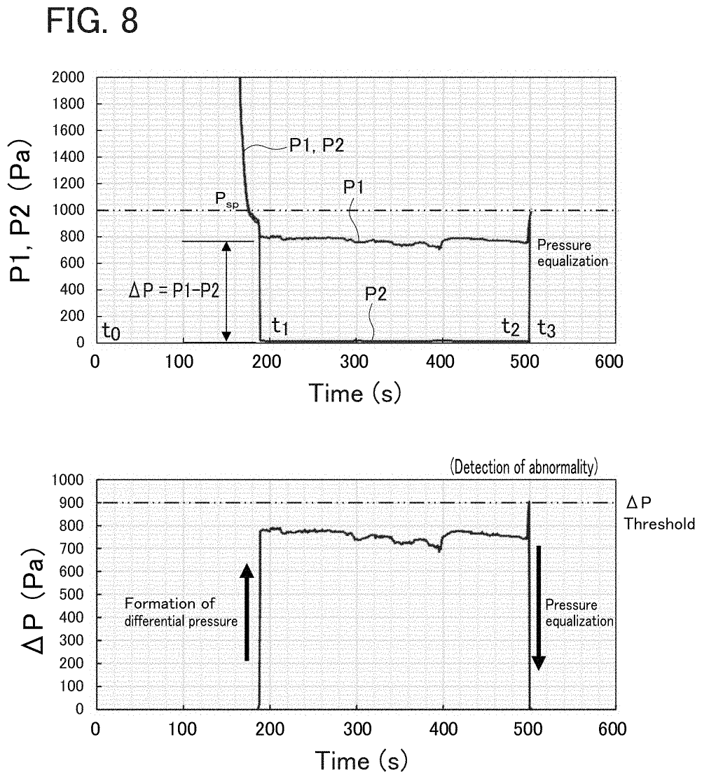

FIG. 8 illustrates the results of an experiment according to the above-described steps using the apparatus D1. Here, the target pressures in the processing chamber v and the chamber 53 after the time t1 were set to P1=800 Pa and P2<50 Pa, respectively, and the threshold for ΔP was set to 900 Pa.

As found from FIG. 8, P1=P2=1000 Pa was established after a lapse of 180 seconds (time t1) from the start of depressurization (t0). Then, the situation transitioned with P1≈800 Pa and P2<15 Pa, and the above-described disturbance was applied after a lapse of 500 seconds (time t2) from the start of depressurization. Almost at the same time, P1 and ΔP surged. The control valve 331 was opened when ΔP>900 Pa (threshold) was reached, so ΔP decreased rapidly. The time required from the surge of P1 due to the opening of the leak valve 34 to the rapid decrease in ΔP due to the operation of the differential pressure gauge 330 and the control valve 331 was extremely short.

The apparatus D1 was stopped, and the pressures in the processing chamber v and chamber 53 were returned to the atmospheric pressure. After that, the recovery filter 52 taken out was observed. When the differential pressure management was performed (P1 and P2 were made equal pressure or ΔP was reduced) after the above-described disturbance was applied, no molten metal adhesion or the like was observed on the recovery filter 52. On the other hand, when the differential pressure management was not performed after the disturbance was applied, the molten metal adhered to the recovery filter 52.

From the above, it has been found that, by introducing the differential pressure management, damage or the like to the apparatus can be avoided even in the event of an abnormality, and fractional distillation and recovery of a specific element can be performed stably.

TABLE 1

| | Condition of purification | | | | | | |
|---|---|---|---|---|---|---|---|
| | Local heating | | | | Local | | |
| | Discharge current | Gas | | Molten metal | low pressure | Processing | |
| Sample | (DC) | flow rate | P1 | temperature | P2 | time | |
| No. | (A) | (L/min) | (Pa) | (° C.) | (Pa) | (sec) | Note |
| 1 | 120 | 3 | 800 | 830 | 15 | 120 | |
| 2 | 120 | 4 | 800 | 950 | 10 | 450 | |
| C1 | — | — | 800 | 750 | 15 | 120 | Without local heating |

※When local heating is performed, processing time is also discharge time.

### DESCRIPTION OF REFERENCE NUMERALS

D Metal purifying apparatus

3 Evacuation unit

4 Local heating unit Local low pressure unit

5 Differential pressure managing unit

33 Al-based molten metal

s1 Molten metal surface (first region)

s2 Molten metal surface (second region)

a Arc discharge

g Gas stream

1. A metal purifying method comprising:
a local heating step of heating an aluminum-based molten metal in a first region on a molten metal surface of the aluminum-based molten metal; and
a local low pressure step of lowering a pressure in a second region on the molten metal surface to a pressure lower than a pressure in the first region, wherein the second region is different from the first region,
wherein a specific element is vaporized from the second region to purify the aluminum-based molten metal.

2. The metal purifying method according to claim 1, wherein the local heating step and the local low pressure step are performed in parallel.

3. The metal purifying method according to claim 1, further comprising
a recovering step of recovering the specific element vaporized from the second region.

4. The metal purifying method according to claim 1, wherein a pressure (P2) on the second region side is set to 0.1 to 1000 Pa.

5. The metal purifying method according to claim 1, wherein a pressure (P1) on the first region side is set to 100 to 10000 Pa.

6. The metal purifying method according to claim 1, wherein a differential pressure (ΔP=P1−P2) between a pressure (P1) on the first region side and a pressure (P2) on the second region side is set to 100 to 5000 Pa.

7. The metal purifying method according to claim 1, further comprising
a differential pressure managing step of setting a differential pressure (ΔP=P1−P2) between a pressure (P1) on the first region side and a pressure (P2) on the second region side within a predetermined range.

8. The metal purifying method according to claim 1, wherein the local heating step is performed by arc discharge.

9. The metal purifying method according to claim 1, wherein the specific element is one or more of Zn, Mg, or Pb.

10. A metal purifying apparatus comprising:
a local heating means that heats an aluminum-based molten metal in a first region on a molten metal surface of the aluminum-based molten metal and
a local low pressure means that lowers a pressure in a second region on the molten metal surface to a pressure lower than a pressure in the first region, wherein the second region is different from the first region,
wherein a specific element can be vaporized from the second region to purify the aluminum-based molten metal.

11. The metal purifying apparatus according to claim 10, further comprising
a recovering means that recovers the specific element vaporized from the second region.

12. The metal purifying apparatus according to claim 10, further comprising
a differential pressure managing means that sets a differential pressure (ΔP=P1−P2) between a pressure (P1) on the first region side and a pressure (P2) on the second region side within a predetermined range.

13. The metal purifying apparatus according to claim 12, wherein the differential pressure managing means is a switching valve or a control valve that can increase the pressure (P2) on the second region side.
